(19) United States
(12) Patent Application Publication
(10) Pub. No.: US 2006/0032448 A1
(43) Pub. Date: Feb. 16, 2006

(54) Shed no more

(76) Inventor: Kevin Schwartz, Wantagh, NY (US)

Correspondence Address: Kevin Schwartz, 252 Aspen Court, Wantagh, NY, 11793, US

(21) Appl. No.: 10/895,479

(22) Filed: Jul. 21, 2004

(51) Int. Cl. A01K 5/00

(52) U.S. Cl. 119/51.01

(57) ABSTRACT

Shed No More is new and innovative product in that there are currently no products in the market that help to prevent non-seasonal shedding in domestic Pets. This product helps to prevent non-seasonal shedding in domestic pets while providing essential oils and nutrients to produce a healthier looking coat.

### CROSS REFERENCE TO RELATED APPLICATION

Not Applicable

### STATEMENT REGARDING FEDERALLY SPONSORED RESEARCH

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Shed No More was created by Kevin Schwartz on or around Oct. 1, 2002 on Long Island New York and is in the classification or field of endeavor of Pet Neutraceuticals. This product was created as a result of Pet owners having animals that were shedding year round. Shed No More helps to prevent non-seasonal shedding by providing the Pet with essential oils and vitamins that the Pet may not be producing itself. Shed No More contains a special blend of natural oils, minerals, antioxidants and vitamins, which can effectively reduce and in many cases stop non-seasonal shedding in Pets while providing a healthier, more lustrous coat. Shed No More will reduce the unwanted shedding without affecting the normal seasonal shedding cycle.

### DETAILED DESCRIPTION OF THE INVENTION

1.) Invention Expanation

Non-seasonal shedding is a problem for most domesticated Pets such as dogs and cats. Therefore, the objective of the invention is to effectively reduce and in many cases stop non-seasonal shedding in domesticated animals while providing a healthier, more lustrous coat. Accordingly Shed No More contains a special blend of natural oils, minerals, antioxidants and vitamins, which can effectively reduce and in many cases stop non-seasonal shedding in Pets while providing a healthier, more lustrous coat. Shed No More will reduce the unwanted shedding without affecting the normal seasonal shedding cycle.

2.) Process of Making

Shed No More is produced by blending in to pill form: Liver, Brewer's Yeast, Maltodextrin Beef Flavor, Cheese Flavor, Silicon Dioxide, Magnesium Stearate, and the following:

| | | |
|---|---|---|
| Proprietary Blend | 225 | mg |
| (Safflower, Sunflower, Flaxseed, Borage, Evening | | |
| Primrose & Fish Oils) | | |
| Lecithin Powder | 150 | mg |
| Flaxseed Oil & Powder | .50 | mg |
| Copper | 1.250 | mg |
| Manganese | 1.250 | mg |
| Zinc | 1.250 | mg |
| Selenium | .002 | mg |
| Vitamin A | 125 | iu |
| Vitamin D-3 | 12.5 | iu |
| Vitamin B-1 | .125 | mg |
| Vitamin B-2 | .125 | mg |
| Vitamin B-6 | .125 | mg |
| Vitamin B-12 | .002 | mg |
| Niacinamide | 1.250 | mg |
| Choline | 2.5 | mg |
| Inositol | 1.25 | mg |

3.) Using the Invention

The Recommended Dosage depends on the size of the dog.

Dogs should be given the following dosages:
Under 25 lbs. 1 tab in the A.M. and 1 tab P.M.
25-60 lbs. 2 tabs in the A.M. and 2 tabs in the P.M.
Over 60 lbs. 3 tabs in the A.M. and 3 tabs in the P.M.

1.) I claim the combination or blend of Shed No More with the special blend of ingredients comprising at least of one or more vitamins, minerals, antioxidants, and natural oil (s) selected from a group consisting of essential vitamins, minerals, and antioxidants.

2.) I claim that Shed No More is a Pet composition according to claim 1, which is a Pet neutraceutical.

3.) I claim that Shed No More is a Pet composition according to claim 1 wherein said essential vitamins, minerals, antioxidants, and natural oils (s) are selected from a group consisting of: Liver, Brewer's Yeast, Maltodextrin Beef Flavor, Cheese Flavor, Silicon Dioxide, Magnesium Stearate, Safflower, Sunflower, Flaxseed, Borage, Evening Primrose, Fish Oils, Lecithin Powder, Flaxseed Oil & Powder, Copper, Manganese, Zinc, Selenium, Vitamin A, Vitamin D-3, Vitamin B-1, Vitamin B-2, Vitamin B-6, Vitamin B-12, Niacinamide, Choline, and Inositol.
